(19) United States
(12) Patent Application Publication
(10) Pub. No.: US 2020/0171923 A1
(43) Pub. Date: Jun. 4, 2020

(54) COLORED AIR FILTER MEDIUM

(71) Applicant: K&N Engineering, Inc., Riverside, CA (US)

(72) Inventor: Steve Williams, Cherry Valley, CA (US)

(73) Assignee: K&N Engineering, Inc., Riverside, CA (US)

(21) Appl. No.: 16/691,587

(22) Filed: Nov. 21, 2019

Related U.S. Application Data
(60) Provisional application No. 62/773,114, filed on Nov. 29, 2018.

(51) Int. Cl. B60H 3/06; B01D 46/00

(52) U.S. Cl. CPC B60H 3/06; B01D 46/0005

(57) ABSTRACT

An apparatus and methods are provided for an aesthetic air filter to remove airborne particulate matter from an airstream. The aesthetic air filter comprises a supportive frame and a colored filter medium retained within the supportive frame. The supportive frame orients the aesthetic air filter within a ventilation system. The filter medium removes the particulate matter from air flowing through the ventilation system. The filter medium is treated with a suitable dye, or other substance, that gives the filter medium an aesthetically pleasing appearance. The filter medium may include a color that matches other nearby engine components, such as braided sheaths on hoses and wires, as well as decorative metallic couplings, and the like. The filter medium may be endowed with any of various desirable colors. The supportive frame may include a color that is coordinated with the color of the filter medium.

### PRIORITY

This application claims the benefit of and priority to U.S. Provisional Application, entitled “Colored Air Filter Medium,” filed on Nov. 29, 2018 and having application Ser. No. 62/773,114, the entirety of said application being incorporated herein by reference.

### FIELD

Embodiments of the present disclosure generally relate to the field of air filters. More specifically, embodiments of the disclosure relate to an apparatus and methods for an aesthetic air filter to remove airborne particulate matter from an airstream.

### BACKGROUND

An air filter designed to remove particulate is generally a device composed of fibrous materials. These fibrous materials may remove solid particulates such as dust, pollen, mold, and bacteria from the air. Air filters are used in applications where air quality is important, notably in building ventilation systems and in automobile engines.

Air filters may be used in automobiles, trucks, tractors, locomotives and other vehicles that use internal combustion engines. Air filters may be used with gasoline engines, diesel engines, or other engines that run on fossil fuels or other combustible substances. Air filters may be used with engines in which combustion is intermittent, such as four-stroke and two-stroke piston engines, as well as other types of engines that take in air so as to burn a combustible substance. For example, air filters may be used with some gas turbines. Filters may also be used with air compressors or in other devices that take in air.

Filters may be made from pleated paper, foam, cotton, spun fiberglass, or other known filter materials. Generally, the air intakes of internal combustion engines and compressors tend to use paper, foam, or cotton filters. Some filters use an oil bath. Air filters for internal combustion engines prevent abrasive particulate matter from entering the engine's cylinders, where it would cause mechanical wear and oil contamination. As such, there is a continuing desire to develop air filters that are capable of advantageously removing airborne particular matter from engine intake airstreams.

### SUMMARY

An apparatus and methods are provided for an aesthetic air filter to remove airborne particulate matter from an airstream. The aesthetic air filter comprises a supportive frame and a colored filter medium retained within the supportive frame. The supportive frame orients the aesthetic air filter within a ventilation system. The filter medium removes the particulate matter from air flowing through the ventilation system. The filter medium is treated with a suitable dye, or other substance, that gives the filter medium an aesthetically pleasing appearance. The filter medium may include a color that matches other nearby engine components, such as braided sheaths on hoses and wires, as well as decorative metallic couplings, and the like. The filter medium may be endowed with any of various desirable colors, such as black, red, blue, grey, silver, gold, orange, and the like. The supportive frame may include a color that is coordinated with the color of the filter medium.

In an exemplary embodiment, an aesthetic air filter comprises: a colored filter medium for removing airborne particulate matter from an airstream; and a supportive frame for retaining the colored filter medium. In another exemplary embodiment, the supportive frame has a shape and size suitable for orienting the aesthetic air filter within a ventilation system. In another exemplary embodiment, the colored filter medium is configured to remove the particulate matter from air flowing through the ventilation system. In another exemplary embodiment, the colored filter medium comprises any of paper, foam, cotton, spun fiberglass, woven, synthetic and/or natural material.

In another exemplary embodiment, suitable fasteners are used to retain the colored filter medium within the supportive frame. In another exemplary embodiment, the supportive frame is molded onto a wire support comprising the colored filter medium. In another exemplary embodiment, the supportive frame comprises a crimped portion that folds onto and retains the wire support and the colored filter medium. In another exemplary embodiment, the colored filter medium is irremovable from the supportive frame.

In another exemplary embodiment, the colored filter medium is treated with a suitable dye, or other substance, to give the colored filter medium an aesthetically pleasing appearance. In another exemplary embodiment, the colored filter medium is treated with a black dye to give the filter medium an appealing black appearance. In another exemplary embodiment, the colored filter medium includes a color that matches the colors of other nearby engine components. In another exemplary embodiment, the colored filter medium is endowed with any of various desirable colors. In another exemplary embodiment, the supportive frame includes a color that is coordinated with the color of the filter medium.

In an exemplary embodiment, a method for an aesthetic air filter comprises: configuring a filter medium for removing airborne particulate matter from an airstream; retaining the filter medium within a supportive frame; and treating the filter medium with a suitable dye to form a colored filter medium.

In another exemplary embodiment, configuring includes forming the filter medium of any of paper, foam, cotton, spun fiberglass, woven, synthetic and/or natural material. In another exemplary embodiment, retaining includes forming a shape and size of the supportive frame suitable for orienting the aesthetic air filter within a ventilation system. In another exemplary embodiment, retaining includes giving the supportive frame a color that is coordinated with the color of the colored filter medium. In another exemplary embodiment, retaining includes molding the supportive frame onto a wire support comprising the colored filter medium. In another exemplary embodiment, retaining includes crimping a portion of the supportive frame that folds onto the wire support of the colored filter medium. In another exemplary embodiment, treating includes applying a color to the filter medium that matches the colors of other nearby engine components.

### BRIEF DESCRIPTION OF THE DRAWINGS

The drawings refer to embodiments of the present disclosure in which:

FIG. 1 illustrates a perspective ghost-view of an exemplary use environment comprising a ventilation system of a vehicle that has an aesthetic air filter that includes a colored air filter medium for filtration of air passing through the air filter;

FIG. 2 illustrates a perspective ghost-view of an exemplary embodiment of a ventilation system comprising an aesthetic air filter including a colored filter medium for filtration of air passing through the air filter;

FIG. 3 illustrates an exemplary embodiment of an aesthetic air filter including a colored filter medium for filtration of air passing through the air filter; and

FIG. 4 illustrates an exemplary embodiment of an aesthetic air filter that includes a colored air filter medium for filtration of air passing through the air filter.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first filter portion,” may be made. However, the specific numeric reference should not be interpreted as a literal sequential order but rather interpreted that the “first filter portion” is different than a “second filter portion.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Embodiments of the present disclosure provide an aesthetic air filter for filtration of an airstream passing through the air filter. The embodiments disclosed herein provide a colored filter medium of the aesthetic air filter that is capable of advantageously removing airborne particular matter from engine intake airstreams.

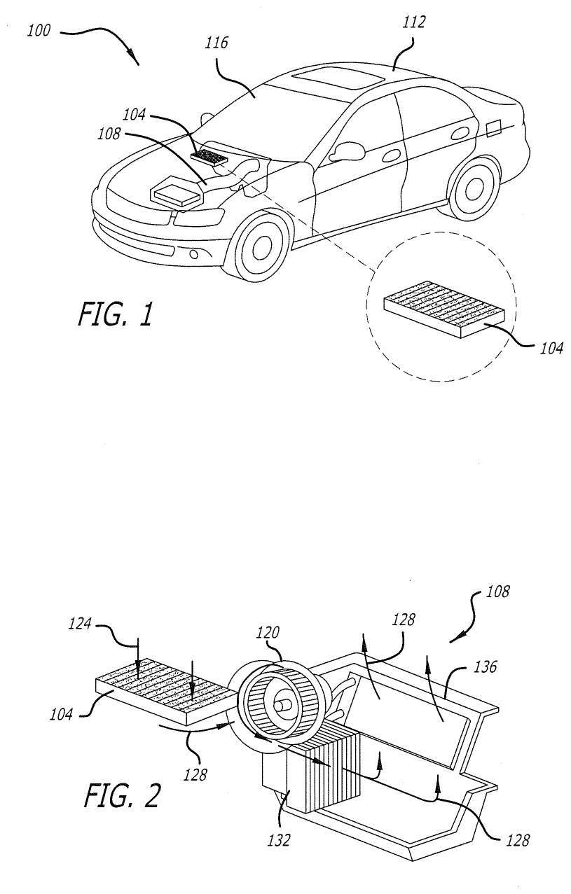

FIG. 1 illustrates an exemplary use environment 100 wherein an aesthetic air filter 104 is incorporated into a ventilation system 108 of a vehicle 112 so as to clean outside air drawn through the aesthetic air filter 104 into a passenger compartment 116. In some embodiments, the aesthetic air filter 104 may be advantageously treated with a filter oil composition that causes tackiness throughout the air filter medium, thereby enhancing airflow and filtration of air passing through the filter 104. As shown in FIG. 2, the ventilation system 108 generally comprises a fan 120 configured to draw an outside air stream 124 through the air filter 104 whereby airborne molecular contaminants, volatile organic compounds, and other particle contaminants are removed from the air stream. Particle contaminants removed from the outside air stream 124 are entrapped in the air filter 104. The fan 120 then pushes a clean air stream 128 into an air conditioning system 132 or a heater core 136 and then into the passenger compartment 116.

It will be appreciated that in some embodiments, the air stream 124 may comprise air drawn from within the passenger compartment 116 rather than outside air. For example, a driver or a passenger may switch the ventilation system 108 to circulate air within the passenger compartment 116, thereby preventing outside air from entering passenger compartment 116. It should be understood, therefore, that in some embodiments the air filter 104 may be implemented so as to remove airborne molecular contaminants, volatile organic compounds, and other particle contaminants from interior air within the passenger compartment 116 being circulated through the ventilation system 108.

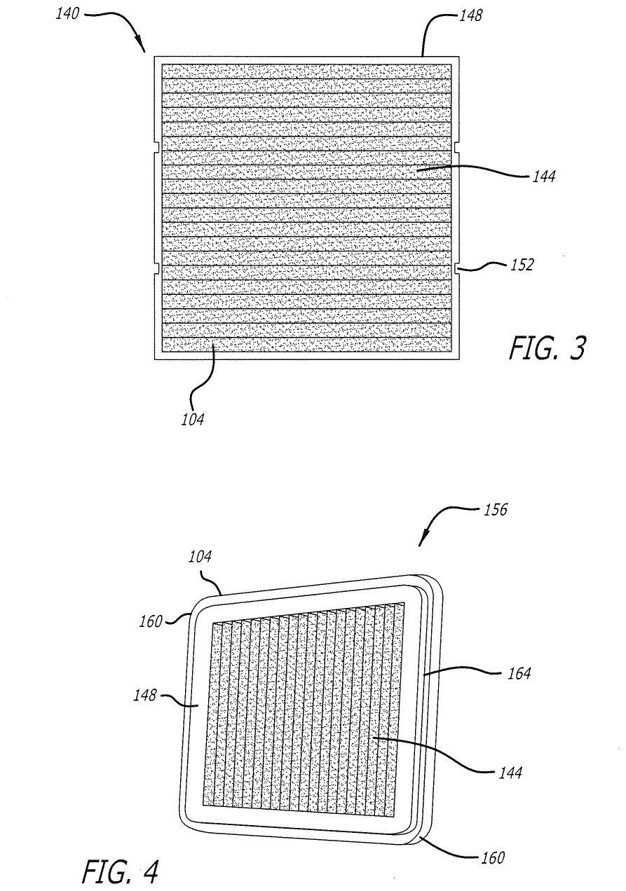

FIG. 3 illustrates an exemplary embodiment 140 of an aesthetic air filter 104 that is configured for filtration of air passing through the air filter 104. The air filter 104 generally comprises a colored filter medium 144 within a supportive frame 148. The supportive frame 148 is configured to orient the air filter 104 within the ventilation system 108 such that the air stream 124 is directed through the colored filter medium 144. As such, the supportive frame 148 comprises a shape and size suitable for supporting the air filter 104 within the ventilation system 108. It will be appreciated that the shape and size of the supportive frame 148 will vary depending upon the make and model of the vehicle 112 for which the filter 104 is intended to be used.

The supportive frame 148 may comprise various fastening structures suitably configured for securing the air filter 104 within a particular ventilation system 108. To this end, in the embodiment illustrated in FIG. 3, the supportive frame 148 comprises a plurality of notches 152 configured to interface with protrusions within the ventilation system 108 of the vehicle 112. In another exemplary embodiment 156, illustrated in FIG. 4, the supportive frame 148 comprises rounded corners 160 and a ridge 164 configured to orient the air filter 104 within the ventilation system 108 of a particular make and model of automobile. Further, the supportive frame 148 illustrated in FIG. 4 has a different shape than the shape of the supportive frame illustrated in FIG. 3. It should be understood, therefore, that the various structures and shapes incorporated into the supportive frame 148, and thus the air filter 104 as a whole, will vary depending upon the make and model of the vehicle 112 for which the aesthetic air filter 104 is intended to be used without detracting from the spirit and scope of the present disclosure.

It will be appreciated that the colored filter medium 144 generally is retained within the supportive frame 148. It is contemplated that any of a variety of fasteners may be used to retain the colored filter medium 144 within the supportive frame 148. In some embodiments, the supportive frame 148 may be molded to a wire support of the colored filter medium 144. In some embodiments, the supportive frame 148 may comprise a crimped portion that folds onto and retains the wire support and the colored filter medium 144 of the aesthetic air filter 104. It will be appreciated that by those skilled in the art that fastening the colored filter medium 144 to the supportive frame 148 renders the colored filter medium 144 irremovable from the supportive frame 148.

It is contemplated that, in some embodiments, the colored filter medium 144 may be treated with a suitable dye, or other substance, to give the colored filter medium 144 an aesthetically pleasing appearance. For example, in some embodiments, the colored filter medium 144 may be treated with a black dye to give the filter medium 144 an appealing black appearance. In some embodiments, wherein the air filter 104 remains visible in an engine compartment, for example, a practitioner may desire a color of the colored filter medium 144 that matches other nearby engine components, such as braided sheaths on hoses and wires, as well as decorative metallic couplings, and the like. As such, it is contemplated that the colored filter medium 144 may be endowed with any of various desirable colors, such as by way of non-limiting example, black, red, blue, grey, silver, gold, orange, and the like. In some embodiments, the supportive frame 148 may include a color that is coordinated with the color of the filter medium 144, without limitation.

It is contemplated that a user of the aesthetic air filter 104 may periodically clean the colored filter medium 144 rather than replacing the air filter 104, as is typically done with conventional air filter systems. It is envisioned that the aesthetic air filter 104 may be removed from the ventilation system 108, the ventilation system 108 cleaned of any debris trapped therein, and then a water hose used to flush contaminants from the colored filter medium 144, thereby leaving the filter clean and ready for reuse. Wherein the colored filter medium 144 has be previously treated with a filter oil composition, a solvent may be used to remove the oil from the colored filter medium 144. Once the colored filter medium 144 is completely dry, a suitably formulated filter oil composition may be uniformly applied and allowed to wick into the colored filter medium 144. The filter oil composition may be applied to the colored filter medium 144 by way of an aerosol spray or a squeeze bottle, as desired. Various other cleaning methods will be apparent to those skilled in the art without deviating from the spirit and scope of the present disclosure.

In some embodiments, the colored filter medium 144 comprises 4 to 6 layers of cotton gauze sandwiched between two epoxy-coated aluminum wire screens. The cotton is advantageously treated with the above-mentioned suitably formulated filter oil composition for causing tackiness throughout microscopic strands comprising the colored filter medium 144. The nature of the cotton allows high volumes of airflow, and when combined with the tackiness of the filter oil composition creates a powerful filtering medium which ensures a high degree of air filtration.

During operation of the ventilation system 108, contaminant particles cling to the fibers within the volume of the colored filter medium 144 and become part of the filtering medium 144, a process referred to as “depth loading.” It will be appreciated that depth loading allows the aesthetic air filter 104 to capture and retain significantly more contaminants per unit of area than conventional air filters. Contaminants collected on the surface of the air filter 104 have little effect on air flow during much of the filter's service life because there are no small holes for the contaminants to clog. Contaminant particles are stopped by the layers of cotton gauze and held in suspension by the filter oil composition. Moreover, as the air filter 104 collects an increasing volume of contaminants and debris, an additional form of filtering action begins to take place because the outside air must first pass through the trapped contaminants on the surface of the colored filter medium 144 before passing through deeper layers within the colored filter medium 144. In essence, the trapped contaminants begin to operate as a filter material which precedes the colored filter medium 144. Thus, the aesthetic air filter 104 continues to exhibit a high degree of air flow and filtration throughout the service life of the filter.

It is contemplated that treating the colored filter medium 144 with the filter oil composition generally enables the colored filter medium 144 to capture contaminants by way of interception, whereby contaminants, such as by way of non-limiting example, dirt particles, traveling with the air stream 124 directly contact the fibers comprising the colored filter medium 144 and are then held in place by the filter oil composition. Larger or heavier particles are generally captured by way of impaction, whereby the inertia or momentum of the particles causes them to deviate from the path of the air stream 124 through the colored filter medium 144, and instead the particles run straight into the fibers and are captured by the filter oil composition.

Particle contaminants having very small sizes may be captured by way of diffusion. Small particles have been found to be highly affected by forces within the air stream 124 through the colored filter medium 144. Forces due to velocity changes, pressure changes, and turbulence caused by other particles, as well as interaction with air molecules, generally causes the small particles to follow random, chaotic flow paths through the colored filter medium 144. Consequently, the small particles do not follow the air stream 124, and their erratic motion causes them to collide with the fibers comprising the colored filter medium 144 and remain captured by the filter oil composition. Diffusion and the filter oil composition enable the air filter 104 to capture particle contaminants having sizes that are much smaller than the openings between the fibers comprising the colored filter medium 144. Furthermore, the filter oil composition enables the air filter 104 to capture contaminants throughout the volume of the colored filter medium 144, rather than only on the surface of the filter as is common with conventional air filters. The multiple layers of cotton fibers comprising the colored filter medium 144 coupled with the tackiness provided by the filter oil composition provide many levels of contaminant retention, thereby enabling the air filter 104 to hold significantly more contaminants per unit of area of the colored filter medium 144 than is possible with conventional air filters.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. An aesthetic air filter, comprising:
a colored filter medium for removing airborne particulate matter from an airstream; and
a supportive frame for retaining the colored filter medium.

2. The air filter of claim 1, wherein the supportive frame has a shape and size suitable for orienting the aesthetic air filter within a ventilation system.

3. The air filter of claim 2, wherein the colored filter medium is configured to remove the particulate matter from air flowing through the ventilation system.

4. The air filter of claim 1, wherein the colored filter medium comprises any of paper, foam, cotton, spun fiberglass, woven, synthetic and/or natural material.

5. The air filter of claim 1, wherein suitable fasteners are used to retain the colored filter medium within the supportive frame.

6. The air filter of claim 1, wherein the supportive frame is molded onto a wire support comprising the colored filter medium.

7. The air filter of claim 6, wherein the supportive frame comprises a crimped portion that folds onto and retains the wire support and the colored filter medium.

8. The air filter of claim 1, wherein the colored filter medium is irremovable from the supportive frame.

9. The air filter of claim 1, wherein the colored filter medium is treated with a suitable dye, or other substance, to give the colored filter medium an aesthetically pleasing appearance.

10. The air filter of claim 9, wherein the colored filter medium is treated with a black dye to give the filter medium an appealing black appearance.

11. The air filter of claim 1, wherein the colored filter medium includes a color that matches the colors of other nearby engine components.

12. The air filter of claim 11, wherein the colored filter medium is endowed with any of various desirable colors.

13. The air filter of claim 12, wherein the supportive frame includes a color that is coordinated with the color of the filter medium.

14. A method for an aesthetic air filter, comprising:
configuring a filter medium for removing airborne particulate matter from an airstream;
retaining the filter medium within a supportive frame; and
treating the filter medium with a suitable dye to form a colored filter medium.

15. The method of claim 14, wherein configuring includes forming the filter medium of any of paper, foam, cotton, spun fiberglass, woven, synthetic and/or natural material.

16. The method of claim 14, wherein retaining includes foiling a shape and size of the supportive frame suitable for orienting the aesthetic air filter within a ventilation system.

17. The method of claim 14, wherein retaining includes giving the supportive frame a color that is coordinated with the color of the colored filter medium.

18. The method of claim 14, wherein retaining includes molding the supportive frame onto a wire support comprising the colored filter medium.

19. The method of claim 18, wherein retaining includes crimping a portion of the supportive frame that folds onto the wire support of the colored filter medium.

20. The method of claim 14, wherein treating includes applying a color to the filter medium that matches the colors of other nearby engine components.
